(19) United States
(12) Patent Application Publication
(10) Pub. No.: US 2026/0213991 A1
(43) Pub. Date: Jul. 23, 2026

(54) RECEPTION METHOD, TRANSMISSION METHOD, RECEPTION DEVICE, TRANSMISSION DEVICE, AND COMMUNICATION SYSTEM

(71) Applicant: Socionext Inc., Kanagawa (JP)

(72) Inventor: Akifumi NAGAO, Yokohama (JP)

(21) Appl. No.: 19/539,638

(22) Filed: Feb. 13, 2026

Related U.S. Application Data
(63) Continuation of application No. PCT/JP2023/032452, filed on Sep. 6, 2023.

(51) Int. Cl. H04L 27/26

(52) U.S. Cl. CPC H04L 27/2628

(57) ABSTRACT

A reception method is used in a communication system that includes a reception device. The reception device includes a normal receiving mode and a power-saving mode. An OFDM scheme defines a plurality of subcarriers that include two or more subcarriers defined as a plurality of first subcarriers. The reception method includes: obtaining a signal level of each of the plurality of first subcarriers in a modulated signal; assigning subcarrier codes based on the signal level of each of the plurality of first subcarriers; assigning, to the modulated signal, a reception code determined based on the subcarrier codes; and changing the operating mode of the reception device based on the reception code. In the changing, the operating mode of the reception device is changed from the power-saving mode to the normal receiving mode, when the reception code and a mode change code match each other.

### CROSS REFERENCE TO RELATED APPLICATION

This is a continuation application of PCT Patent Application No. PCT/JP2023/032452 filed on Sep. 6, 2023, designating the United States of America. The entire disclosure of the above-identified application, including the specification, drawings and claims is incorporated herein by reference in its entirety.

### FIELD

The present disclosure relates to a reception method, a transmission method, a reception device, a transmission device, and a communication system.

### BACKGROUND

Conventionally, communication systems using power line communication (PLC) and the like are known. For example, in an electric kickboard, a plurality of control levers and switches are located on the main body. As a communication system for transmitting control signals from these operating levers and switches, a PLC communication system that has no wiring other than a power line is easy to install and therefore highly convenient. Specifically, when the motor output is controlled by an operating lever installed on the handle of the electric kickboard and information such as speed is displayed on a display located on the handle, control signals are transmitted via a transmission device, a PLC line, and a reception device of the communication system. In such a system, power is supplied to the display, the communication system, and the motor from a battery. In the communication system described above, when no driving operation is performed, the reception device and the like are kept in a power-saving mode (so-called sleep mode), which has low power consumption. This is an attempt to increase the battery operation duration by reducing the power consumed by the communication system and the like.

### CITATION LIST

### Patent Literature

PTL 1: Japanese Unexamined Patent Application No. 2009-21678

### SUMMARY

### Technical Problem

In the above-described communication system, a wake-up signal is transmitted from the transmission device to the reception device when the reception device and/or the like are/is changed from the power-saving mode to a normal mode. As the wake-up signal, for example, a signal with a predetermined time-domain waveform is transmitted. However, in, e.g., a PLC line of an electric kickboard, noise from a motor and/or the like is likely to occur. Therefore, noise superimposed on a wake-up signal that has a predetermined time-domain waveform may cause the reception device to fail to distinguish the wake-up signal or to misjudge the noise as a wake-up signal. In the communication system described in Patent Literature (PTL) 1, a noise cancellation technique is disclosed; however, since the noise cancellation technique disclosed in PTL 1 is a technique that can only be used when the reception device is in normal mode, this technique cannot be used for the noise cancellation of wake-up signals.

Accordingly, the present disclosure provides a reception method and the like that enable realizing a wake-up signal that has high noise immunity.

### Solution to Problem

A reception method according to one aspect of the present disclosure is a reception method used in a communication system that includes a transmission device and a reception device and performs communication by using an Orthogonal Frequency Division Multiplexing (OFDM) scheme, the reception device including a normal receiving mode and a power-saving mode each of which serves as an operating mode of the reception device, the power-saving mode being a mode in which the reception device consumes less power than in the normal receiving mode, the OFDM scheme defining a plurality of subcarriers that include two or more subcarriers defined as a plurality of first subcarriers, the reception method including: receiving a modulated signal modulated by using the OFDM scheme; obtaining a signal level of each of the plurality of first subcarriers in the modulated signal; assigning a plurality of subcarrier codes to the plurality of first subcarriers, on a one-to-one basis, based on the signal level of each of the plurality of first subcarriers; assigning, to the modulated signal, a reception code determined based on the plurality of subcarrier codes; and changing the operating mode of the reception device based on the reception code, wherein in the changing, the operating mode of the reception device is changed from the power-saving mode to the normal receiving mode, when the reception code and a mode change code that is defined in advance match each other.

A transmission method according to one aspect of the present disclosure is a transmission method used in a communication system that includes a transmission device and a reception device and performs communication by using an Orthogonal Frequency Division Multiplexing (OFDM) scheme, the reception device including a normal receiving mode and a power-saving mode each of which serves as an operating mode of the reception device, the power-saving mode being a mode in which the reception device consumes less power than in the normal receiving mode, the transmission method including: determining, for each of a plurality of subcarriers defined by the OFDM scheme, data to be transmitted; performing Inverse Fast Fourier Transform (IFFT) on each of the plurality of subcarriers; and converting, to analog data, digital data output in the performing, wherein the transmission device includes a normal transmission mode and a wake-up signal transmission mode each of which is an operating mode of the transmission device, the wake-up signal transmission mode being a mode in which the transmission device transmits a wake-up signal for changing the operating mode of the reception device from the power-saving mode to the normal receiving mode, the wake-up signal includes a plurality of codes each corresponding to a different one of the plurality of subcarriers, and in the wake-up signal transmission mode, digital data input in the converting is the digital data output in the performing, when the data determined in the determining corresponds to the wake-up signal.

A reception device according to one aspect of the present disclosure is a reception device that performs communication by using an Orthogonal Frequency Division Multiplexing (OFDM) scheme, the reception device including a normal receiving mode and a power-saving mode each of which serves as an operating mode of the reception device, the power-saving mode being a mode in which the reception device consumes less power than in the normal receiving mode, the OFDM scheme defining a plurality of subcarriers that include two or more subcarriers defined as a plurality of first subcarriers, the reception device including: a signal level obtainer that receives a modulated signal modulated by using the OFDM scheme and obtains a signal level of each of the plurality of first subcarriers in the modulated signal; a subcarrier code assigner that assigns a plurality of subcarrier codes to the plurality of first subcarriers, on a one-to-one basis, based on the signal level of each of the plurality of first subcarriers; a reception code assigner that assigns, to the modulated signal, a reception code determined based on the plurality of subcarrier codes; and an operating mode changer that changes the operating mode of the reception device based on the reception code, wherein the operating mode changer changes the operating mode of the reception device from the power-saving mode to the normal receiving mode, when the reception code and a mode change code defined in advance match each other.

A transmission device according to one aspect of the present disclosure is a transmission device that communicates with a reception device by using an Orthogonal Frequency Division Multiplexing (OFDM) scheme, the reception device including a normal receiving mode and a power-saving mode each of which serves as an operating mode of the reception device, the power-saving mode being a mode in which the reception device consumes less power than in the normal receiving mode, the transmission device including: a mapper that determines, for each of a plurality of subcarriers defined by the OFDM scheme, data to be transmitted; an Inverse Fast Fourier Transform (IFFT) component that performs IFFT on each of the plurality of subcarriers; and a digital-to-analog (D/A) converter that converts, to analog data, digital data output by the IFFT component, wherein the transmission device includes a normal transmission mode and a wake-up signal transmission mode each of which serves as an operating mode of the transmission device, the wake-up signal transmission mode being a mode in which the transmission device transmits a wake-up signal for changing the operating mode of the reception device from the power-saving mode to the normal receiving mode, the wake-up signal includes a plurality of codes each corresponding to a different one of the plurality of subcarriers, and in the wake-up signal transmission mode, digital data input to the D/A converter is the digital data output by the IFFT component, when the data determined by the mapper corresponds to the wake-up signal.

A communication system according to one aspect of the present disclosure is a communication system that performs communication by using an Orthogonal Frequency Division Multiplexing (OFDM) scheme, the communication system including: a transmission device; and a reception device, wherein the reception device includes a normal receiving mode and a power-saving mode each of which serves as an operating mode of the reception device, the power-saving mode being a mode in which the reception device consumes less power than in the normal receiving mode, the OFDM scheme defining a plurality of subcarriers that include two or more subcarriers defined as a plurality of first subcarriers, the reception device includes: a signal level obtainer that receives a modulated signal modulated by using the OFDM scheme and determines a signal level of each of the plurality of first subcarriers in the modulated signal; a subcarrier code assigner that assigns a plurality of subcarrier codes to the plurality of first subcarriers, on a one-to-one basis, based on the signal level of each of the plurality of first subcarriers; a reception code assigner that assigns, to the modulated signal, a reception code determined based on the plurality of subcarrier codes; and an operating mode changer that changes the operating mode of the reception device based on the reception code, and the operating mode changer changes the operating mode of the reception device from the power-saving mode to the normal receiving mode, when the reception code and a mode change code defined in advance match each other.

### Advantageous Effects

The present disclosure can provide a reception method and the like that enable realizing a wake-up signal that has high noise immunity.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1A is a first block diagram illustrating an overview of the functional configuration of a communication system according to Embodiment 1.

FIG. 1B is a second block diagram illustrating the overview of the functional configuration of the communication system according to Embodiment 1.

FIG. 2 is a block diagram illustrating the functional configuration of a transmission device according to Embodiment 1.

FIG. 3 is a diagram illustrating an example of a wake-up signal according to Embodiment 1.

FIG. 4 is a block diagram illustrating the functional configuration of a reception device according to Embodiment 1.

FIG. 5 is a block diagram illustrating the functional configuration of a wake-up signal detector according to Embodiment 1.

FIG. 6 is a graph illustrating the frequencies of signals output by an oscillator according to Embodiment 1.

FIG. 7 is a schematic graph illustrating the frequency distribution of a modulated signal corresponding to the wake-up signal illustrated in FIG. 3.

FIG. 8 is a schematic graph illustrating the frequency distribution of the output signal of a mixer when the modulated signal according to Embodiment 1 and a signal at frequency f1 are input to the mixer.

FIG. 9 is a schematic graph illustrating the frequency distribution of the output signal of the mixer when the modulated signal according to Embodiment 1 and a signal at frequency f2 are input to the mixer.

FIG. 10 is a schematic graph illustrating the frequency dependence of the gain of a low-pass filter according to Embodiment 1.

FIG. 11 is a schematic graph illustrating an example of the frequency distribution of the output signal of the low-pass filter according to Embodiment 1.

FIG. 12 is a sequence diagram illustrating the overview of an operating mode-changing method used in the communication system according to Embodiment 1.

FIG. 13 is a flowchart illustrating a transmission method used in the communication system according to Embodiment 1.

FIG. 14 is a flowchart illustrating a reception method used in the communication system according to Embodiment 1.

FIG. 15 is a block diagram illustrating the functional configuration of a transmission device according to Embodiment 2.

FIG. 16 is a diagram illustrating a configuration example of a reception code according to a variation.

### DESCRIPTION OF EMBODIMENTS

Hereinafter, embodiments are described in detail with reference to the drawings. It should be noted that each of the embodiments described shows a specific example of the present disclosure. The numerical values, shapes, materials, specifications, constituent elements, the arrangement and connection of the constituent elements, steps, the processing order of the steps, etc., indicated in the following embodiments are mere examples, and thus are not intended to limit the present disclosure. Furthermore, among the elements described in the following embodiments, elements not recited in any one of the independent claims that indicate the broadest concepts of the present disclosure are described as optional elements. Furthermore, the figures are schematic illustrations and are not necessarily accurate depictions. Elements which are substantially the same have the same reference signs in the figures, and duplicate description may be omitted or simplified.

### Embodiment 1

A reception method, a transmission method, a reception device, a transmission device, and a communication system according to Embodiment 1 are described.

### [1-1. Communication System]

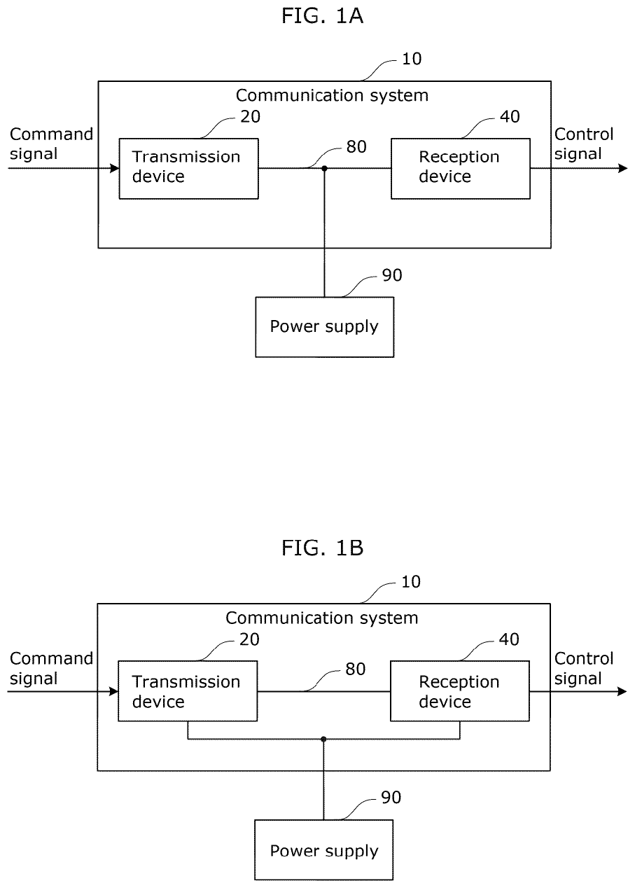

The communication system according to the present embodiment is described with reference to FIG. 1A and FIG. 1B. FIG. 1A and FIG. 1B are a first and a second block diagram, respectively, illustrating overviews of the functional configuration of communication system 10 according to the present embodiment. FIG. 1A and FIG. 1B also illustrate power supply 90 that supplies power to communication system 10.

As illustrated in FIG. 1A, communication system 10 according to the present embodiment is a system that includes transmission device 20 and reception device 40, and communicates using an Orthogonal Frequency Division Multiplexing (OFDM) scheme. In the present embodiment, communication system 10 further includes communication line 80 that connects transmission device 20 and reception device 40 to each other. Communication system 10 is applied to an electric kickboard, for example. Communication system 10 can be used for, e.g., the remote speed control of an electric kickboard. Specifically, when the operator of the electric kickboard operates a command signal input device such as a speed switch located on the handlebar or the like of the electric kickboard, a command signal corresponding to this operation is sent to transmission device 20 of communication system 10. A signal corresponding to this command signal is transmitted to reception device 40 via transmission device 20 and communication line 80. Then, a control signal corresponding to the command signal is transmitted from reception device 40 to a control device such as the motor device of the electric kickboard. In the present embodiment, communication system 10 uses PLC. In other words, communication system 10 performs communication by using a power line to supply power from power supply 90 to transmission device 20 and reception device 40.

It should be noted that FIG. 1A illustrates an example in which communication system 10 includes one transmission device 20 and one reception device 40, but the configuration of communication system 10 is not limited thereto. For example, communication system 10 may include one or more transmission devices 20 and one or more reception device 40, connected to each other by communication line 80.

Power supply 90 provides power to communication system 10. For example, a battery or the like can be used as power supply 90.

Communication line 80 is a line for performing communication between transmission device 20 and reception device 40. In the present embodiment, communication line 80 is also used as a power line that supplies power from power supply 90.

It should be noted that communication line 80 need not necessarily be used to supply power from power supply 90 to transmission device 20 and reception device 40. In other words, communication system 10 need not necessarily use PLC. For example, as illustrated in FIG. 1B, power may be supplied from power supply 90 to transmission device 20 and reception device 40 by using a power line other than communication line 80.

Transmission device 20 is a device that communicates with reception device 40 by using the OFDM scheme. In the present embodiment, transmission device 20 receives a command signal and transmits, to reception device 40, a modulated signal based on the command signal. Transmission device 20 has at least a normal transmission mode and a wake-up signal transmission mode each of which serves as an operating mode of transmission device 20. The wake-up signal transmission mode is a mode in which transmission device 20 transmits a wake-up signal for changing the operating mode of reception device 40 from a power-saving mode to a normal receiving mode. In the present embodiment, transmission device 20 further has a power-saving mode that serves as an operating mode. The power-saving mode is a mode in which transmission device 20 consumes less power than in the normal transmission mode. In the normal transmission mode, transmission device 20 transmits, to reception device 40, a modulated signal that corresponds to the command signal received. When transmission device 20 receives a command signal in the power-saving mode, the operating mode of transmission device 20 switches to the wake-up signal transmission mode, and transmission device 20 sends a wake-up signal to reception device 40 to switch the operating mode of reception device 40 from the power-saving mode to the normal receiving mode. When a ready signal indicating that the operating mode of reception device 40 has been switched to the normal receiving mode is received from reception device 40, the operating mode of transmission device 20 switches to the normal transmission mode.

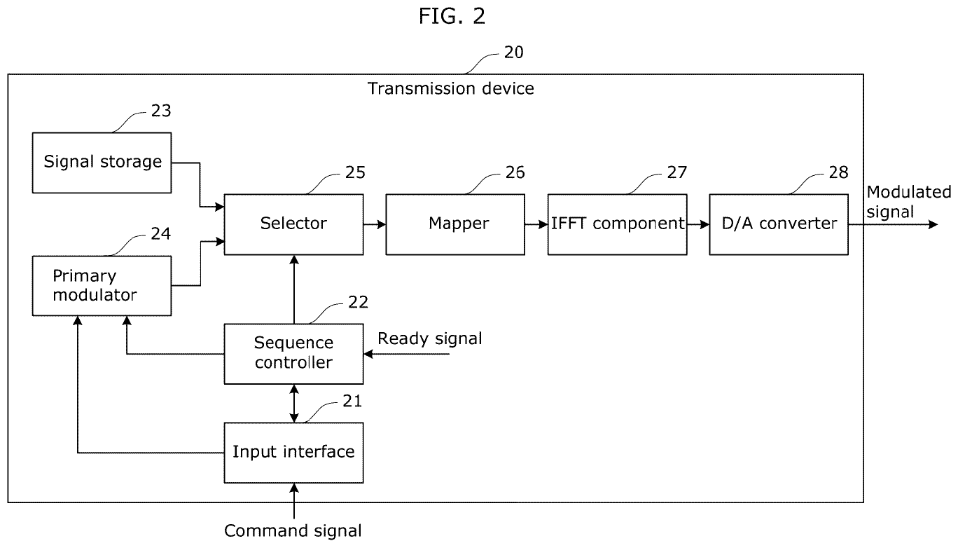

The configuration of transmission device 20 according to the present embodiment will be explained with reference to FIG. 2. FIG. 2 is a block diagram illustrating the functional configuration of transmission device 20 according to the present embodiment.

As illustrated in FIG. 2, transmission device 20 according to the present embodiment includes: input interface 21; sequence controller 22; signal storage 23; primary modulator 24; selector 25; mapper 26; Inverse Fast Fourier Transform (IFFT) component 27; and digital-to-analog (D/A) converter 28.

Input interface 21 is an interface that receives the command signal transmitted to transmission device 20. When input interface 21 receives the command signal, the operation mode of transmission device 20 switches from the power-saving mode to the wake-up signal transmission mode. In the present embodiment, when the command signal is received, input interface 21 transmits a trigger signal to sequence controller 22. When input interface 21 receives a wake-up completion signal from sequence controller 22, transmission device 20 switches to the normal transmission mode, and input interface 21 transmits, to primary modulator 24, command data corresponding to the command signal.

Sequence controller 22 is a processor that controls selector 25. In the wake-up signal transmission mode, sequence controller 22 transmits, to selector 25, a signal for causing selector 25 to output the wake-up signal. In the normal transmission mode, sequence controller 22 transmits, to selector 25, a signal for causing selector 25 to output a signal from primary modulator 24. In the wake-up signal transmission mode and the power-saving mode, sequence controller 22 may transmit a signal for causing operation of primary modulator 24 to stop. When the ready signal is received from reception device 40, sequence controller 22 switches the operating mode of transmission device 20 to the normal transmission mode. In the normal transmission mode, sequence controller 22 may transmit a signal for causing primary modulator 24 to operate.

Signal storage 23 stores a signal corresponding to the wake-up signal. Signal storage 23 outputs the wake-up signal to selector 25. In the present embodiment, the wake-up signal includes a plurality of codes corresponding to a plurality of subcarriers defined by the OFDM scheme. In other words, each of the plurality of subcarriers and each of the plurality of codes correspond to each other on a one-to-one basis. For example, the code value of each of the plurality of codes is either 0 or 1. In the present embodiment, the code value of at least one code is 0. Of the plurality of subcarriers defined by the OFDM scheme, two or more subcarriers may be defined as a plurality of first subcarriers, and the wake-up signal may include a plurality of codes that correspond to the plurality of first subcarriers. In other words, the wake-up signal may be a code corresponding to the plurality of first subcarriers that are some of the plurality of subcarriers. In the present embodiment, all of the subcarriers defined by the OFDM scheme are defined as the plurality of first subcarriers.

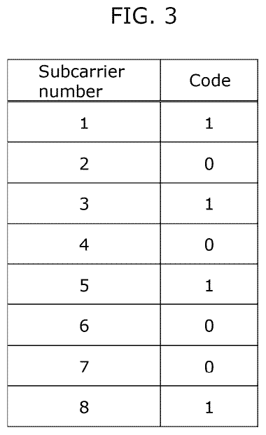

One example of the wake-up signal stored by signal storage 23 is described with reference to FIG. 3. FIG. 3 is a diagram illustrating an example of the wake-up signal according to the present embodiment. FIG. 3 illustrates an example in which subcarrier numbers indicating each of the plurality of subcarriers are combined with codes corresponding, on a one-to-one basis, to each of the plurality of subcarriers. It should be noted that FIG. 3 illustrates an example in which the total number of subcarriers is 8, but the total number of subcarriers is not limited thereto. For example, the total number of subcarriers may be as high as 200.

In a signal transmitted in the normal transmission mode, the plurality of items of data corresponding to the plurality of subcarriers are typically non-zero. Thus, in reception device 40, it can be reliably identified whether the modulated signal received corresponds to the wake-up signal or a normal signal. Moreover, the power consumed by wake-up signal detector 50 for this identification can be suppressed. Furthermore, since the wake-up signal according to the present embodiment is not a time-domain waveform but consists of a plurality of codes each corresponding to a different one of the plurality of subcarriers, the wake-up signal can be easily distinguished from noise applied to all of the plurality of subcarriers.

Primary modulator 24 is a processor that modulates the command data received from input interface 21. Primary modulator 24 outputs the modulated command data to selector 25. Primary modulator 24 performs modulation by using, for example, a Binary Phase Shift Keying (BPSK) scheme, a Quadrature Amplitude Modulation (QAM) scheme, or the like. Primary modulator 24 may, based on the signal from sequence controller 22, stop operation, in the power-saving mode.

Selector 25 selects a signal to be output to mapper 26. In the present embodiment, based on the signal from sequence controller 22, selector 25 selects one of: the wake-up signal that is the input signal from signal storage 23; or the input signal from primary modulator 24, and outputs the selected signal to mapper 26.

Mapper 26 is a processor that determines data to be transmitted for each of the plurality of subcarriers defined by the OFDM scheme. Based on the signal input from selector 25, mapper 26 determines data to be transmitted for each of the plurality of subcarriers, and outputs, to IFFT component 27, a signal that includes the determined data.

IFFT component 27 is a processor that performs Inverse Fast Fourier Transform on each of the plurality of subcarriers. IFFT component 27 outputs, to D/A converter 28, digital data subjected to Inverse Fast Fourier Transform.

D/A converter 28 is a processor that converts the digital data output by IFFT component 27 to analog data. The analog data is transmitted, as a modulated signal, to reception device 40 via communication line 80. In the wake-up signal transmission mode, when the data determined by mapper 26 corresponds to the wake-up signal, the digital data input to D/A converter 28 is the digital data output by IFFT component 27. In the normal transmission mode, when the data determined by mapper 26 corresponds to the signal from primary modulator 24, the digital data input to D/A converter 28 is the digital data output by IFFT component 27.

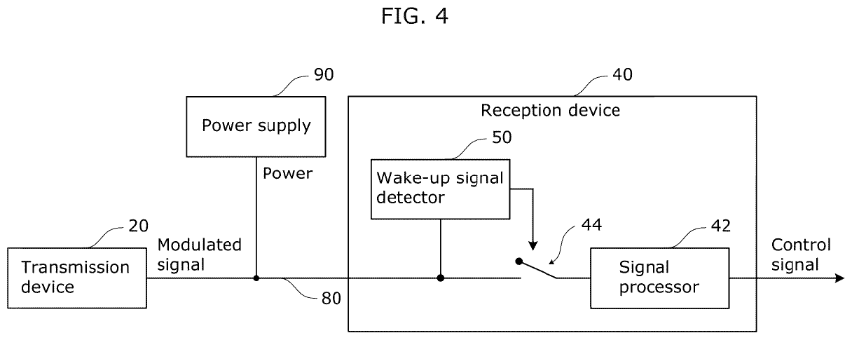

Reception device 40 is a device that communicates by using the OFDM scheme. Reception device 40 receives the modulated signal from transmission device 20, via communication line 80. Reception device 40 outputs a control signal based on the modulated signal received. Reception device 40 has a normal receiving mode and a power-saving mode each of which is an operating mode of reception device 40. The power-saving mode is a mode in which reception device 40 consumes less power than in the normal receiving mode. The configuration of reception device 40 will be described with reference to FIG. 4. FIG. 4 is a block diagram illustrating the functional configuration of reception device 40 according to the present embodiment. FIG. 4 also illustrates transmission device 20, power supply 90, and communication line 80.

As illustrated in FIG. 4, reception device 40 includes: signal processor 42; switch 44; and wake-up signal detector 50.

Signal processor 42 is a processor that demodulates the modulated signal transmitted from transmission device 20. In the normal receiving mode, signal processor 42 outputs a control signal corresponding to the command signal input to transmission device 20, by demodulating the modulated signal. More specifically, in signal processor 42, processes such as an analog-to-digital (A/D) conversion process, a Fast Fourier Transform process, and a demodulation process are performed.

The A/D conversion process is a process in which the modulated signal, which is analog data, is converted to digital data. The Fast Fourier Transform process is a process in which the digital data is subjected to Fast Fourier Transform. The demodulation process is a process in which demodulation corresponding to the modulation in primary modulator 24 of transmission device 20 is performed.

In signal processor 42, processing is not performed in the power-saving mode. In the present embodiment, the supply of power from power supply 90 is stopped in the power-saving mode. This makes it possible to reduce the power consumption in the power-saving mode. It should be noted that the power consumption reduction method used in signal processor 42 is not limited thereto. For example, the power consumption in signal processor 42 may be reduced by stopping the supply, to signal processor 42, of a clock signal that determines the timing of the operation of signal processor 42, without stopping the supply of power from power supply 90.

Signal processor 42 transmits a ready signal to transmission device 20, when the operating mode of reception device 40 is switched from the power-saving mode to the normal receiving mode.

Switch 44 switches the state of supplying the power from power supply 90 to signal processor 42. In the present embodiment, switch 44 also switches the state of supplying the modulated signal from transmission device 20 to signal processor 42. Switch 44 is inserted within a line that connects power supply 90 and transmission device 20 with signal processor 42, and switches the connection state (an on state or an off state) between: power supply 90 and transmission device 20; and signal processor 42, based on a signal from wake-up signal detector 50.

It should be noted that the configuration of switch 44 and the like are not limited thereto. For example, in a case in which reception device 40 has a separating circuit that separates: the power supplied from power supply 90 via communication line 80; and the modulated signal supplied from transmission device 20 via communication line 80, switch 44 may switch, among the states of supplying the power and the modulated signal to signal processor 42, only the state of supplying the power. In this case, the modulated signal may be constantly supplied to signal processor 42. In such a configuration as well, the power consumption in signal processor 42 can be reduced.

Wake-up signal detector 50 is a processor that detects the wake-up signal included in the modulated signal transmitted from transmission device 20. Wake-up signal detector 50 switches the operating mode of reception device 40 from the power-saving mode to the normal receiving mode, when the wake-up signal is detected in the power-saving mode. In the present embodiment, the operating mode of reception device 40 is switched from the power-saving mode to the normal receiving mode by switching switch 44 from the off state to the on state and causing the supply of power from power supply 90 to signal processor 42 to start. In the present embodiment, the supply of the modulated signal from transmission device 20 to signal processor 42 is also caused to start, by switching switch 44 from the off state to the on state.

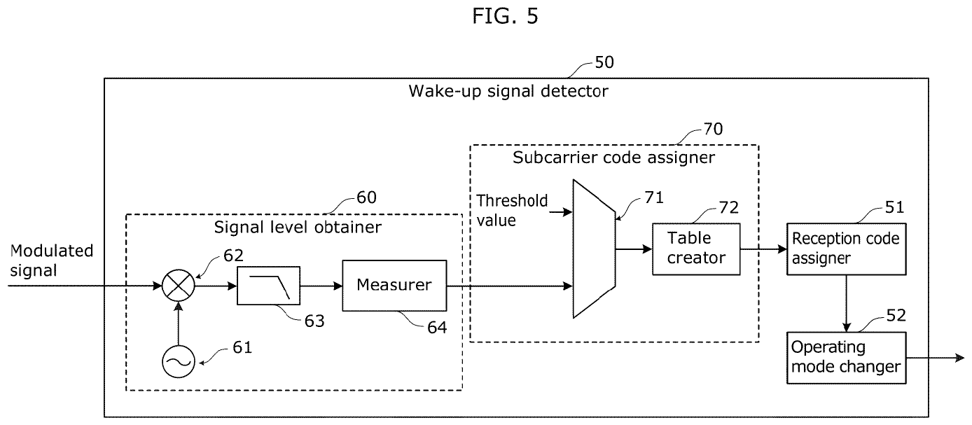

The configuration of wake-up signal detector 50 will be described with reference to FIG. 5. FIG. 5 is a block diagram illustrating the functional configuration of wake-up signal detector 50 according to the present embodiment.

As illustrated in FIG. 5, wake-up signal detector 50 according to the present embodiment includes: signal level obtainer 60; subcarrier code assigner 70; reception code assigner 51; and operating mode changer 52.

Signal level obtainer 60 receives the modulated signal modulated by transmission device 20 using the OFDM scheme, and obtains a signal level, in the modulated signal, of each of the plurality of subcarriers. In the present embodiment, signal level obtainer 60 includes: oscillator 61; mixer 62; low-pass filter 63; and measurer 64.

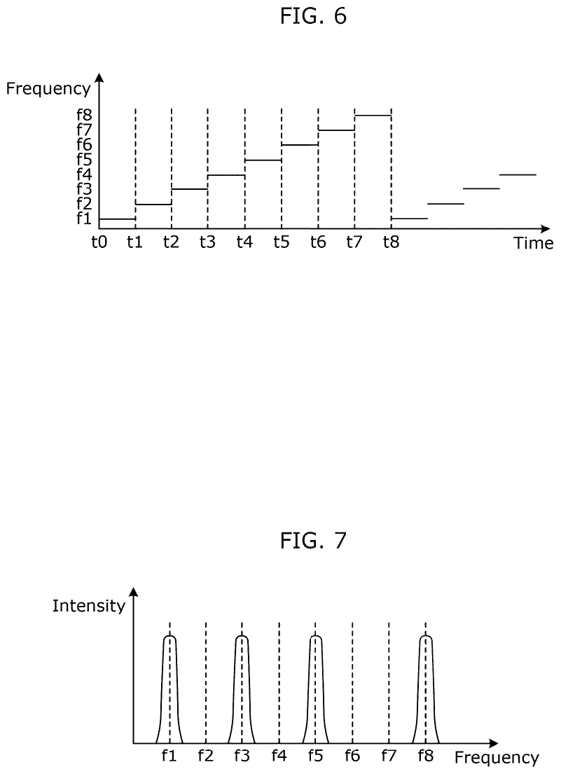

Oscillator 61 is a device that outputs signals having frequencies equal to those of each of the plurality of subcarriers. Here, the output signals of oscillator 61 are described with reference to FIG. 6. FIG. 6 is a graph illustrating the frequency of the signals output by oscillator 61 according to the present embodiment. In the present embodiment, as illustrated in FIG. 6, oscillator 61 sequentially outputs signals at frequencies (f1 to f8) equivalent to each of the plurality of subcarriers. In the example illustrated in FIG. 6, oscillator 61 outputs a signal at frequency f1 from time t0 to time t1, outputs a signal at frequency f2 (>f1) from time t1 to time t2, outputs a signal at frequency f3 (>f2) from time t2 to time t3, outputs a signal at frequency f4 (>f3) from time t3 to time t4, outputs a signal at frequency f5 (>f4) from time t4 to time t5, outputs a signal at frequency f6 (>f5) from time t5 to time t6, outputs a signal at frequency f7 (>f6) from time t6 to time t7, and outputs a signal at frequency f8 (>f7) from time t7 to time t8.

Mixer 62 is a circuit that multiplies the modulated signal by the output signal of oscillator 61. Here, the output signal of mixer 62 will be described.

The modulated signal input to mixer 62 is represented by the following formula (1), assuming that n=1, 2, . . . , 8.

$$Σ ( An \times sin ( 2 n \times fn \times t ) ) = Σ ( A n \times sin ( ω n \times t ) ) \qquad ( 1 )$$

It should be noted that in formula (1), An denotes the amplitude of the component at frequency fn of the modulated signal.

Furthermore, the output signal of oscillator 61 is expressed by the following formula (2).

$$B \times sin ( 2 n \times fosc \times t ) = B \times sin ( ω \times t ) \qquad ( 2 )$$

Therefore, the output signal of mixer 62 is expressed by the following formula (3).

$$Σ ( An \times sin ( ω n \times t ) ) \times B \times sin ( ω \times t ) = Σ ( An \times B \times sin ( ω n \times t ) \times sin ( ω \times t ) ) = ( 1 / 2 ) \times Σ ( An \times B \times ( cos ( ( ω n - ω ) \times t ) - cos ( ( ω n + ω ) \times t ) ) ) \qquad ( 3 )$$

Here, the frequency ((ωn+ω)×t) is larger than ((ωn−ω)×t), and if the term cos ((ωn+ω)×t) is ignored on the assumption that the high-frequency component will later be filtered out by low-pass filter 63, the above formula (3) can be approximated by the following formula (4).

$$( 1 / 2 ) \times Σ ( An \times B \times ( cos ( ( ω n - ω ) \times t ) ) ) \qquad ( 4 )$$

When ω1 is substituted for ω and n=2, 3, . . . , formula (4) is expressed by the following formula (5).

$$A 1 \times B \times ( 1 / 2 ) \times cos ( 0 ) + ( 1 / 2 ) Σ ( An \times B \times ( cos ( ( ω n - ω ) \times t ) ) ) = A 1 \times B \times ( 1 / 2 ) + ( 1 / 2 ) Σ ( An \times B \times ( cos ( ( ω n - ω ) \times t ) ) ) \qquad ( 5 )$$

Here, the term cos((ωn−ω)×t) is ignored because it is a high-frequency component compared to A1×B×(½). Therefore, the signal level of the term for which the frequency of the output signal of mixer 62, when the frequency of the signal from oscillator 61 is f1, is zero is determined by the operation A1×B×(½).

The signal level of the term for which the frequency of the output signal of mixer 62 is zero for each of frequencies f2 to f8 of the signal from oscillator 61 is similarly determined by the operation An×B×(½) (n=2, 3, . . . , 8).

For example, the frequency distribution of the modulated signal corresponding to the wake-up signal illustrated in FIG. 3 is described with reference to FIG. 7. FIG. 7 is a schematic graph illustrating the frequency distribution of the modulated signal corresponding to the wake-up signal illustrated in FIG. 3.

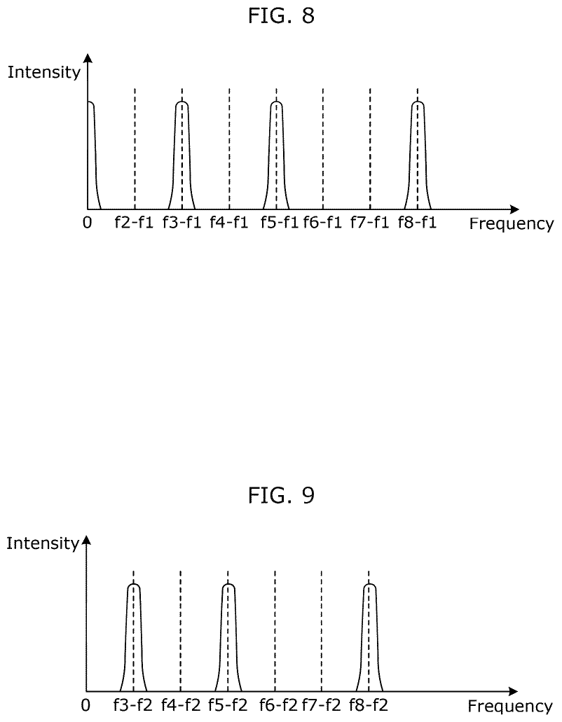

The frequency distribution of the output signal of mixer 62 when such a modulated signal and a signal at frequency f1 or frequency f2 are input to mixer 62 is described with reference to FIG. 8 and FIG. 9. FIG. 8 is a schematic graph illustrating the frequency distribution of the output signal of mixer 62 when the modulated signal according to the present embodiment and a signal at frequency f1 are input to the mixer. FIG. 9 is a schematic graph illustrating the frequency distribution of the output signal of mixer 62 when the modulated signal according to the present embodiment and a signal at frequency f2 are input to the mixer.

As illustrated in FIG. 8, when a signal at frequency f1 is output from oscillator 61 to mixer 62, the frequency f1 component of the modulated signal is output from mixer 62 as the zero-frequency component. Furthermore, the frequency f3, f5, and f8 components of the modulated signal are output from mixer 62 as the frequency f3−f1, f5−f1, and f8−f1 components.

As illustrated in FIG. 9, when a signal at frequency f2 is output from oscillator 61 to mixer 62, the frequency f2 component of the modulated signal is output from mixer 62 as the zero-frequency component. Furthermore, the frequency f3, f5, and f8 components of the modulated signal are output from mixer 62 as the frequency f3−f2, f5−f2, and f8−f2 components.

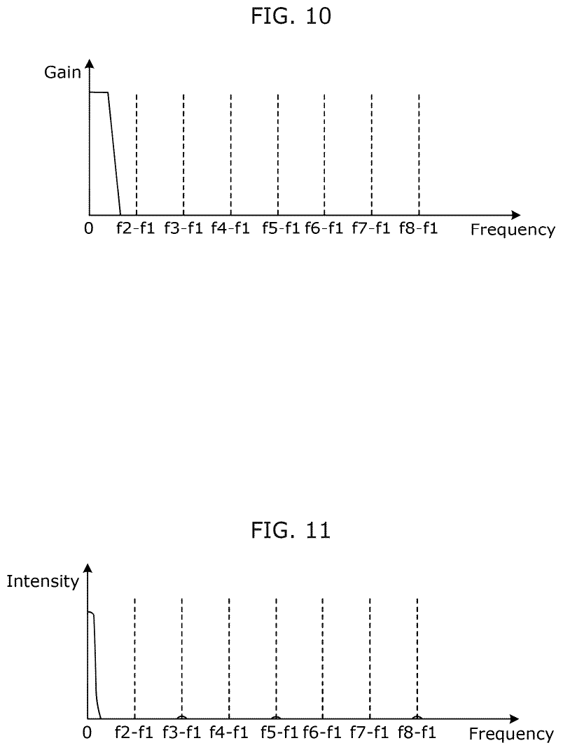

Low-pass filter 63 is a filter that reduces the high-frequency component of the output signal from mixer 62 and allows the low-frequency component to pass through. An example of the characteristics of low-pass filter 63 is described with reference to FIG. 10 and FIG. 11. FIG. 10 is a schematic graph illustrating the frequency dependence of the gain of low-pass filter 63 according to the present embodiment. FIG. 11 is a schematic graph illustrating an example of the frequency distribution of the output signal of low-pass filter 63 according to the present embodiment.

As illustrated in FIG. 10, low-pass filter 63 according to the present embodiment reduces the frequency components at and above frequency f2−f1 and allows only the components near zero frequency to pass through. Thus, for example, when a signal such as that illustrated in FIG. 8 is input to low-pass filter 63, substantially only the components near zero frequency are output from low-pass filter 63, as illustrated in FIG. 11.

By using oscillator 61, mixer 62, and low-pass filter 63 that are as described above, a signal with waveforms that correspond to the intensity of each subcarrier and are arranged in the time axis direction can be generated.

Measurer 64 measures the signal level of each subcarrier of the modulated signal. In the present embodiment, the signal level of each of the plurality of first subcarriers is measured by measuring the signal level of the components near zero frequency in the output signal of low-pass filter 63. For example, an envelope detection circuit can be used as measurer 64. Measurer 64 outputs the measured signal level.

Subcarrier code assigner 70 assigns a plurality of subcarrier codes to the plurality of first subcarriers, on a one-to-one basis, based on the signal level of each of the plurality of first subcarriers. In the present embodiment, subcarrier code assigner 70 includes comparator 71 and table creator 72.

Comparator 71 compares the signal level of each of the plurality of first subcarriers output from measurer 64 with a predetermined threshold value, and outputs a judgment result indicating whether the signal level is greater or less. Furthermore, the predetermined threshold value that is compared to the signal level of each of the plurality of first subcarriers in comparator 71 is the same in each comparison. In other words, the signal level of each of the plurality of first subcarriers is compared to the same threshold value.

Table creator 72 creates a table in which each of the plurality of subcarrier codes is assigned based on the results of the comparison, by comparator 71, between the predetermined threshold value and the signal level of each of the plurality of first subcarriers. For example, table creator 72 creates a table that associates each of the plurality of first subcarriers, the signal level of each of the plurality of first subcarriers (or the signal level indicated by the output signal of comparator 71), and each of the plurality of subcarrier codes. For example, table creator 72 assigns 1 as the subcarrier code corresponding to the first subcarrier(s) having a signal level greater than the predetermined threshold value, and 0 as the subcarrier code corresponding to the first subcarrier(s) having a signal level less than or equal to the predetermined threshold value. It should be noted that table creator 72 can identify which first subcarrier each signal level corresponds to based on, e.g., a clock signal used to define the signal output timing of oscillator 61.

Reception code assigner 51 assigns, to the modulated signal, a reception code determined based on the plurality of subcarrier codes. In the present embodiment, reception code assigner 51 outputs the reception code to operating mode changer 52. The code length of the reception code is equal to the total number of the plurality of first subcarriers. In other words, reception code assigner 51 uses the plurality of subcarrier codes as-is, as the plurality of codes included in the reception code. It should be noted that the code length of the reception code need not be equal to the total number of the plurality of first subcarriers. For example, one code included in the reception code may be generated based on two or more subcarrier codes of the plurality of subcarrier codes. Furthermore, the reception code may also include information identifying the transmission source from which the modulated signal has been transmitted. For example, when communication system 10 includes a plurality of transmission devices 20, the plurality of transmission devices 20 may each have a wake-up signal corresponding to a different reception code. This makes it possible for reception device 40 to identify which transmission device 20 is the transmission source, when communication system 10 includes a plurality of transmission devices 20.

Operating mode changer 52 changes the operating mode of reception device 40 based on the reception code. Operating mode changer 52 changes the operating mode of reception device 40 from the power-saving mode to the normal receiving mode, when the reception code matches a mode change code that is defined in advance. Operating mode changer 52 keeps the operating mode of reception device 40 unchanged when the reception code and the mode change code do not match. It should be noted that an arbitrary code can be used as the mode change code. The wake-up signal corresponding to the arbitrarily defined mode change code is used in transmission device 20.

### [1-2. Operating Mode-Changing Method Used in Communication System]

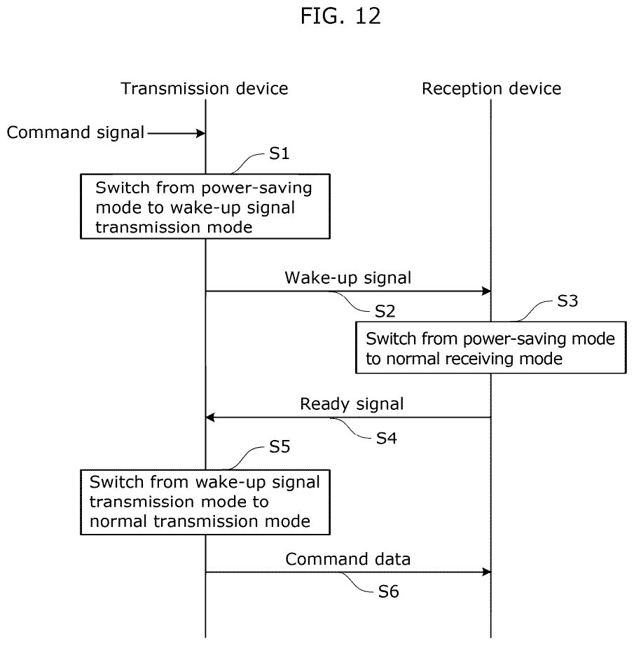

An overview of an operating mode-changing method used in communication system 10 according to the present embodiment will be described with reference to FIG. 12. FIG. 12 is a sequence diagram illustrating the overview of the operating mode-changing method used in communication system 10 according to the present embodiment. FIG. 12 illustrates a method for changing the operating modes of transmission device 20 and reception device 40 of communication system 10 from the power-saving mode to the normal transmission mode and the normal receiving mode, respectively.

As illustrated in FIG. 12, when transmission device 20 whose operating mode is the power-saving mode receives a command signal, the operating mode is switched from the power-saving mode to the wake-up signal transmission mode (S1).

Next, transmission device 20 transmits a wake-up signal to reception device 40 (S2). In the present embodiment, transmission device 20 transmits, to reception device 40, a wake-up signal modulated by the OFDM scheme.

Next, reception device 40, which has received the wake-up signal, switches its operating mode from the power-saving mode to the normal receiving mode (S3).

Next, after the operating mode of reception device 40 has been switched to the normal receiving mode, reception device 40 transmits a ready signal to transmission device 20 (S4). Reception device 40 thus notifies transmission device 20 that the switching of the operating mode of reception device 40 to the normal receiving mode is complete.

Next, when transmission device 20 receives the ready signal from reception device 40, transmission device 20 switches its operating mode from the wake-up signal transmission mode to the normal transmission mode (S5).

Next, when the operating mode of transmission device 20 has been switched to the normal transmission mode, transmission device 20 transmits, to reception device 40, command data corresponding to the command signal (S6).

As described above, in communication system 10 according to the present embodiment, transmission device 20 and reception device 40, whose operating modes are the power-saving mode, are switched to the normal transmission mode and the normal receiving mode, respectively.

### [1-3. Transmission Method Used in Communication System]

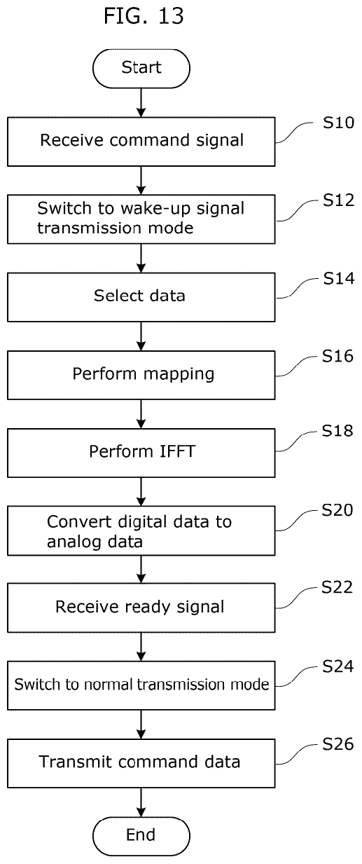

A transmission method used in communication system 10 according to the present embodiment will be described with reference to FIG. 13. FIG. 13 is a flowchart illustrating a transmission method used in communication system 10 according to the present embodiment.

When the operating mode of transmission device 20 of communication system 10 is the power-saving mode, transmission device 20 receives a command signal (S10). In the present embodiment, input interface 21 of transmission device 20 receives the command signal.

Next, transmission device 20 switches its operating mode from the power-saving mode to the wake-up signal transmission mode (S12).

Next, transmission device 20 selects, as data to be transmitted, data corresponding to the wake-up signal (S14). In the present embodiment, selector 25 of transmission device 20 selects, as the data to be transmitted, the data corresponding to the wake-up signal, based on the signal from sequence controller 22. The wake-up signal includes a plurality of codes each corresponding to a different one of the plurality of subcarriers.

Next, transmission device 20 performs mapping by determining data to be transmitted for each of the plurality of subcarriers defined using the OFDM scheme (S16). In the present embodiment, mapper 26 of transmission device 20 determines the data to be transmitted for each of the plurality of subcarriers.

Next, transmission device 20 performs Inverse Fast Fourier Transform on each of the plurality of subcarriers (S18). In the present embodiment, IFFT component 27 of transmission device 20 performs Inverse Fast Fourier Transform on each of the plurality of subcarriers.

Next, transmission device 20 converts the digital data output in step S12 to analog data (S20). In the present embodiment, D/A converter 28 of transmission device 20 converts the digital data output from IFFT component 27 to analog data.

Next, transmission device 20 receives a ready signal from reception device 40, which has received the wake-up signal (S22). In the present embodiment, sequence controller 22 of transmission device 20 receives the ready signal.

Next, transmission device 20 switches its operating mode from the wake-up signal transmission mode to the normal transmission mode (S24). In the present embodiment, sequence controller 22 transmits a signal to selector 25 to cause selector 25 to select the signal from primary modulator 24. Furthermore, sequence controller 22 causes the operation of primary modulator 24 to start.

Next, transmission device 20 transmits, to reception device 40, command data corresponding to the command signal (S26). In the present embodiment, input interface 21 transmits, to primary modulator 24, the command data corresponding to the command signal. Primary modulator 24 modulates the command data, and transmits the modulated command data to selector 25. Selector 25 selects the modulated command data from primary modulator 24, and outputs the modulated command data to mapper 26. Mapper 26 determines the data to be transmitted for each of the plurality of subcarriers, based on the modulated command data. IFFT component 27 performs Inverse Fast Fourier Transform on each of the plurality of subcarriers. D/A converter 28 of transmission device 20 converts the digital data output from IFFT component 27 to analog data, and transmits the analog data to reception device 40 as a modulated signal.

As described above, the transmission method according to the present embodiment makes it possible to switch the operating mode of reception device 40 to the normal receiving mode, by transmitting a wake-up signal to reception device 40 whose operating mode is the power-saving mode. In the present embodiment, the wake-up signal includes a plurality of codes each corresponding to a different one of the plurality of subcarriers defined using the OFDM scheme, and data corresponding to at least one of the plurality of subcarriers can be zero. In signals transmitted in the normal transmission mode, the plurality of items of data corresponding to the plurality of subcarriers are typically non-zero. Thus, in reception device 40, it can be reliably identified whether the modulated signal received corresponds to the wake-up signal or a normal signal. Moreover, the power consumed by wake-up signal detector 50 for this identification can be suppressed. Furthermore, since the wake-up signal according to the present embodiment is not a time-domain waveform but consists of a plurality of codes each corresponding to a different one of the plurality of subcarriers, the wake-up signal can be easily distinguished from noise applied to all of the plurality of subcarriers.

### [1-4. Reception Method Used in Communication System]

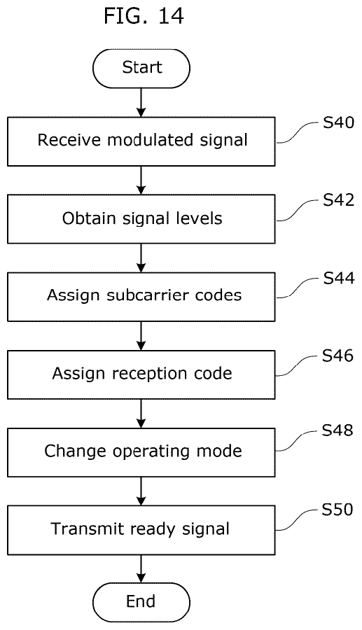

An overview of a reception method used in communication system 10 according to the present embodiment will be described with reference to FIG. 14. FIG. 14 is a flowchart illustrating a reception method used in communication system 10 according to the present embodiment.

As illustrated in FIG. 14, reception device 40 in communication system 10 receives a modulated signal modulated using the OFDM scheme, when the operating mode of reception device 40 is the power-saving mode (S40). In the present embodiment, wake-up signal detector 50, which operates even in the power-saving mode, receives the modulated signal.

Next, wake-up signal detector 50 of reception device 40 obtains the signal level of each of the plurality of first subcarriers. The signal level is included in the modulated signal (S42). In the present embodiment, signal level obtainer 60 of wake-up signal detector 50 obtains the signal level.

Next, wake-up signal detector 50 assigns a plurality of subcarrier codes to a plurality of first subcarriers, on a one-to-one basis, based on the signal level of each of the plurality of first subcarriers (S44). In the present embodiment, subcarrier code assigner 70 of wake-up signal detector 50 assigns the plurality of subcarrier codes to the plurality of first subcarriers on a one-to-one basis.

Next, wake-up signal detector 50 assigns, to the modulated signal, a reception code determined based on the plurality of subcarrier codes (S46). In the present embodiment, reception code assigner 51 of wake-up signal detector 50 assigns the reception code to the modulated signal.

Next, wake-up signal detector 50 changes the operating mode of reception device 40, based on the reception code (S48). In step S48, operating mode changer 52 of wake-up signal detector 50 changes the operating mode of reception device 40 from the power-saving mode to the normal receiving mode, when the reception code matches a mode change code that is defined in advance.

Next, reception device 40 transmits a ready signal to transmission device 20 (S50). In the present embodiment, signal processor 42 of reception device 40 transmits the ready signal to transmission device 20.

As described above, the reception method according to the present embodiment makes it possible to switch the operating mode of reception device 40 to the normal receiving mode, by transmitting a wake-up signal to reception device 40 whose operating mode is the power-saving mode. In the present embodiment, the wake-up signal includes a plurality of codes each corresponding to a different one of the plurality of subcarriers defined using the OFDM scheme, and data corresponding to at least one of the plurality of subcarriers can be zero. In the signal modulated using the OFDM scheme, the plurality of items of data corresponding to the plurality of subcarriers are typically non-zero. Thus, in reception device 40, it can be reliably identified whether the modulated signal received corresponds to the wake-up signal or a normal signal. Moreover, the power consumed by wake-up signal detector 50 for this identification can be suppressed. Furthermore, since the wake-up signal according to the present embodiment is not a time-domain waveform but consists of a plurality of codes each corresponding to a different one of the plurality of subcarriers, the wake-up signal can be easily distinguished from noise applied to all of the plurality of subcarriers.

### [1-5. Effects, Etc.]

The aspects and effects of the reception method, the transmission method, reception device 40, transmission device 20, and communication system 10 according to the present embodiment will be described.

A reception method according to aspect 1 of the present embodiment is a reception method used in communication system 10 that includes transmission device 20 and reception device 40 and performs communication by using an Orthogonal Frequency Division Multiplexing (OFDM) scheme, reception device 40 including a normal receiving mode and a power-saving mode each of which serves as an operating mode of reception device 40, the power-saving mode being a mode in which reception device 40 consumes less power than in the normal receiving mode, the OFDM scheme defining a plurality of subcarriers that include two or more subcarriers defined as a plurality of first subcarriers, the reception method including: receiving a modulated signal modulated by using the OFDM scheme; obtaining a signal level of each of the plurality of first subcarriers in the modulated signal; assigning a plurality of subcarrier codes to the plurality of first subcarriers, on a one-to-one basis, based on the signal level of each of the plurality of first subcarriers; assigning, to the modulated signal, a reception code determined based on the plurality of subcarrier codes; and changing the operating mode of reception device 40 based on the reception code, wherein in the changing, the operating mode of reception device 40 is changed from the power-saving mode to the normal receiving mode, when the reception code and a mode change code that is defined in advance match each other.

The reception method of aspect 1 makes it possible to switch the operating mode of reception device 40 to the normal receiving mode, by transmitting a wake-up signal to reception device 40 whose operating mode is the power-saving mode. The wake-up signal includes a plurality of codes each corresponding to a different one of the plurality of subcarriers defined using the OFDM scheme, and data corresponding to at least one of the plurality of subcarriers can be zero. In the signal modulated using the OFDM scheme, the plurality of items of data corresponding to the plurality of subcarriers are typically non-zero. Thus, in reception device 40, it can be reliably identified whether the modulated signal received corresponds to the wake-up signal or a normal signal. Moreover, the power consumed by wake-up signal detector 50 for this identification can be suppressed. Furthermore, since the wake-up signal according to the present embodiment is not a time-domain waveform but consists of a plurality of codes each corresponding to a different one of the plurality of subcarriers, the wake-up signal can be easily distinguished from noise applied to all of the plurality of subcarriers.

A reception method according to aspect 2 of the present embodiment is the reception method according to aspect 1, in which in the assigning of the plurality of subcarrier codes, each of the plurality of subcarrier codes is assigned based on a result of comparison between a predetermined threshold value and the signal level.

This makes it possible to easily assign subcarrier codes by, for example, setting the subcarrier code to 1 when the signal level is greater than the predetermined threshold, and setting the subcarrier code to 0 when the signal level is less than or equal to the predetermined threshold.

A reception method according to aspect 3 of the present embodiment is the reception method according to aspect 2, in which in the assigning of the plurality of subcarrier codes, the predetermined threshold value that is compared to the signal level of each of the plurality of first subcarriers is same in each comparison.

This makes it possible to simplify the reception method.

A reception method according to aspect 4 of the present embodiment is the reception method according to any one of aspects 1 to 3, in which the reception code includes information identifying a transmission source from which the modulated signal has been transmitted.

This makes it possible, for example, for reception device 40 to easily identify which transmission device 20 is the transmission source that transmitted the modulated signal, when communication system 10 includes a plurality of transmission devices 20.

A reception method according to aspect 5 of the present embodiment is the reception method according to any one of aspects 1 to 4, in which a code length of the reception code is equal to a total number of the plurality of first subcarriers.

This makes it possible to simplify the assigning of the reception code.

A reception method according to aspect 6 of the present embodiment is the reception method according to any one of aspects 1 to 5, in which an arbitrary code is usable as the mode change code.

This makes it possible to enhance the flexibility of the reception method.

A transmission method according to aspect 1 of the present embodiment is a transmission method used in communication system 10 that includes transmission device 20 and reception device 40 and performs communication by using an Orthogonal Frequency Division Multiplexing (OFDM) scheme, reception device 40 including a normal receiving mode and a power-saving mode each of which serves as an operating mode of reception device 40, the power-saving mode being a mode in which reception device 40 consumes less power than in the normal receiving mode, the transmission method including: determining, for each of a plurality of subcarriers defined by the OFDM scheme, data to be transmitted; performing Inverse Fast Fourier Transform (IFFT) on each of the plurality of subcarriers; and converting, to analog data, digital data output in the performing, wherein transmission device 20 includes a normal transmission mode and a wake-up signal transmission mode each of which is an operating mode of transmission device 20, the wake-up signal transmission mode being a mode in which transmission device 20 transmits a wake-up signal for changing the operating mode of reception device 40 from the power-saving mode to the normal receiving mode, the wake-up signal includes a plurality of codes each corresponding to a different one of the plurality of subcarriers, and in the wake-up signal transmission mode, digital data input in the converting is the digital data output in the performing, when the data determined in the determining corresponds to the wake-up signal.

The transmission method of aspect 1 makes it possible to switch the operating mode of reception device 40 to the normal receiving mode, by transmitting, to reception device 40 whose operating mode is the power-saving mode, a wake-up signal. The wake-up signal includes a plurality of codes each corresponding to a different one of the plurality of subcarriers defined by the OFDM scheme, and data corresponding to at least one of the plurality of subcarriers can be 0. In signals transmitted in the normal transmission mode, the plurality of items of data corresponding to the plurality of subcarriers are typically non-zero. Thus, in reception device 40, it can be reliably identified whether the modulated signal received corresponds to the wake-up signal or a normal signal. Moreover, the power consumed by wake-up signal detector 50 for this identification can be suppressed. Furthermore, since the wake-up signal according to the present embodiment is not a time-domain waveform but consists of a plurality of codes each corresponding to a different one of the plurality of subcarriers, the wake-up signal can be easily distinguished from noise applied to all of the plurality of subcarriers.

Reception device 40 according to aspect 1 of the present embodiment is reception device 40 that performs communication by using an Orthogonal Frequency Division Multiplexing (OFDM) scheme, reception device 40 including a normal receiving mode and a power-saving mode each of which serves as an operating mode of reception device 40, the power-saving mode being a mode in which reception device 40 consumes less power than in the normal receiving mode, the OFDM scheme defining a plurality of subcarriers that include two or more subcarriers defined as a plurality of first subcarriers, reception device 40 including: signal level obtainer 60 that receives a modulated signal modulated by using the OFDM scheme and obtains a signal level of each of the plurality of first subcarriers in the modulated signal; subcarrier code assigner 70 that assigns a plurality of subcarrier codes to the plurality of first subcarriers, on a one-to-one basis, based on the signal level of each of the plurality of first subcarriers; reception code assigner 51 that assigns, to the modulated signal, a reception code determined based on the plurality of subcarrier codes; and operating mode changer 52 that changes the operating mode of reception device 40 based on the reception code, wherein operating mode changer 52 changes the operating mode of reception device 40 from the power-saving mode to the normal receiving mode, when the reception code and a mode change code defined in advance match each other.

Reception device 40 of aspect 1 achieves effects similar to those of the reception method of aspect 1.

Transmission device 20 according to aspect 1 of the present embodiment is transmission device 20 that communicates with reception device 40 by using an Orthogonal Frequency Division Multiplexing (OFDM) scheme, reception device 40 including a normal receiving mode and a power-saving mode each of which serves as an operating mode of reception device 40, the power-saving mode being a mode in which reception device 40 consumes less power than in the normal receiving mode, transmission device 20 including: mapper 26 that determines, for each of a plurality of subcarriers defined by the OFDM scheme, data to be transmitted; Inverse Fast Fourier Transform (IFFT) component 27 that performs IFFT on each of the plurality of subcarriers; and digital-to-analog (D/A) converter 28 that converts, to analog data, digital data output by IFFT component 27, wherein transmission device 20 includes a normal transmission mode and a wake-up signal transmission mode each of which serves as an operating mode of transmission device 20, the wake-up signal transmission mode being a mode in which transmission device 20 transmits a wake-up signal for changing the operating mode of reception device 40 from the power-saving mode to the normal receiving mode, the wake-up signal includes a plurality of codes each corresponding to a different one of the plurality of subcarriers, and in the wake-up signal transmission mode, digital data input to D/A converter 28 is the digital data output by IFFT component 27, when the data determined by mapper 26 corresponds to the wake-up signal.

Transmission device 20 of aspect 1 achieves effects similar to those of the transmission method of aspect 1.

Communication system 10 according to aspect 1 of the present embodiment is communication system 10 that performs communication by using an Orthogonal Frequency Division Multiplexing (OFDM) scheme, communication system 10 including: transmission device 20; and reception device 40, wherein reception device 40 includes a normal receiving mode and a power-saving mode each of which serves as an operating mode of reception device 40, the power-saving mode being a mode in which reception device 40 consumes less power than in the normal receiving mode, the OFDM scheme defining a plurality of subcarriers that include two or more subcarriers defined as a plurality of first subcarriers, reception device 40 includes: signal level obtainer 60 that receives a modulated signal modulated by using the OFDM scheme and determines a signal level of each of the plurality of first subcarriers in the modulated signal; subcarrier code assigner 70 that assigns a plurality of subcarrier codes to the plurality of first subcarriers, on a one-to-one basis, based on the signal level of each of the plurality of first subcarriers; reception code assigner 51 that assigns, to the modulated signal, a reception code determined based on the plurality of subcarrier codes; and operating mode changer 52 that changes the operating mode of reception device 40 based on the reception code, and operating mode changer 52 changes the operating mode of reception device 40 from the power-saving mode to the normal receiving mode, when the reception code and a mode change code defined in advance match each other.

Communication system 10 of aspect 1 achieves effects similar to those of the reception method of aspect 1.

### Embodiment 2

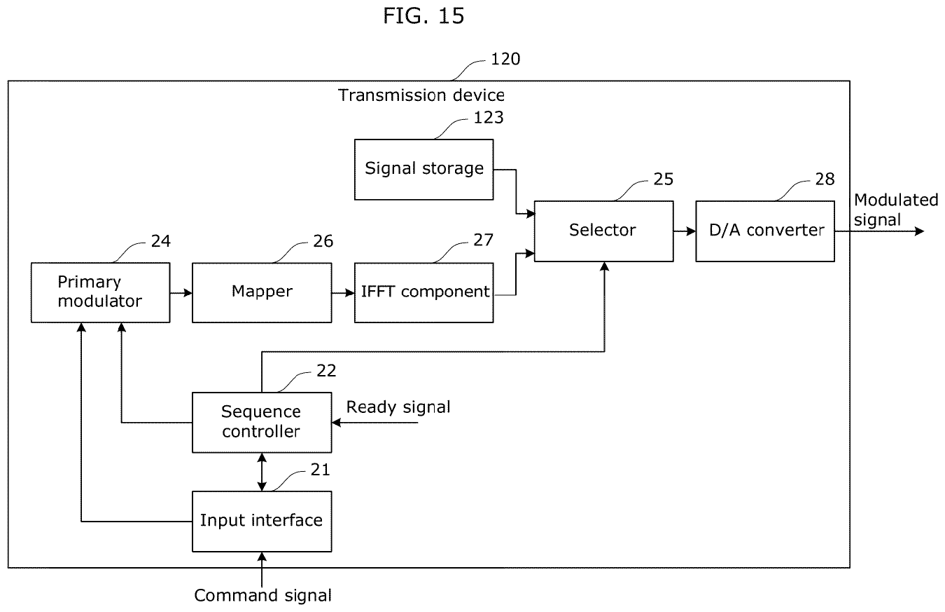

A transmission device according to Embodiment 2 will be described below. The transmission device according to the present embodiment is different from transmission device 20 according to Embodiment 1, mainly in, e.g., the features of the signal storage that stores the signal corresponding to the wake-up signal. Hereinafter, the transmission device according to the present embodiment will be described focusing on the differences from transmission device 20 according to Embodiment 1, with reference to FIG. 15. FIG. 15 is a block diagram illustrating the functional configuration of transmission device 120 according to the present embodiment.

As illustrated in FIG. 15, transmission device 120 according to the present embodiment includes: input interface 21; sequence controller 22: signal storage 123; primary modulator 24; selector 25; mapper 26; IFFT component 27; and D/A converter 28.

In the present embodiment, the output signal of IFFT component 27 and a signal corresponding to the wake-up signal from signal storage 123 are input to selector 25.

Signal storage 123 stores a signal corresponding to the wake-up signal. In the present embodiment, signal storage 123 stores a signal corresponding to the signal output from IFFT component 27, when a wake-up signal similar to that of Embodiment 1 is input to mapper 26. In other words, signal storage 123 maps the wake-up signal to a plurality of subcarriers, and stores a signal corresponding to a signal subjected to Inverse Fast Fourier Transform. Specifically, signal storage 123 stores, for example, data obtained by discretizing a time-domain waveform of the signal. Thus, the storage capacity required for signal storage 123 is significantly greater than the storage capacity required for signal storage 23 according to Embodiment 1. However, since processing of the wake-up signal by mapper 26 and IFFT component 27 is unnecessary, the power consumption in wake-up signal transmission mode can be reduced compared to Embodiment 1.

### Variations, Etc.

The reception method and the like of the present disclosure have been described above based on the embodiments, but the present disclosure is not intended to be limited to these embodiments. Forms obtained by various modifications to the respective embodiments that can be conceived by a person skilled in the art as well as other forms realized by combining some constituent elements in the respective embodiments are included in the scope of the present disclosure as long as they do not depart from the essence of the present disclosure.

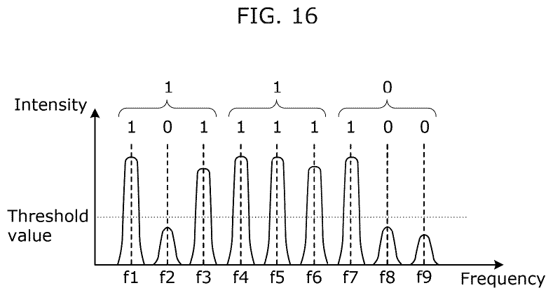

For example, in the embodiments described above, the code length of the reception code was equal to the total number of the plurality of first subcarriers, but the configuration of the reception code is not limited thereto. Hereinafter, another configuration example of the reception code is explained with reference to FIG. 16. FIG. 16 is a diagram illustrating a configuration example of the reception code according to a variation.

In step S46 (the assigning of the reception code) illustrated in FIG. 14: the plurality of subcarrier codes may be assigned to a plurality of groups; a group code may be assigned to each group of the plurality of groups based on a subcarrier code, among the plurality of subcarrier codes, that is included in the group; and the reception code may be assigned based on the group code assigned to each group of the plurality of groups. In the example illustrated in FIG. 16, nine subcarriers at frequencies f1 to f9 are defined. For each subcarrier, when the intensity of the subcarrier is greater than the threshold value, 1 is assigned as the subcarrier code, and when the intensity of the subcarrier is less than or equal to the threshold value, 0 is assigned as the subcarrier code. In the example illustrated in FIG. 16, the nine subcarrier codes are assigned, based on the frequencies of the subcarriers (the first subcarriers), to three groups at frequencies f1 to f3, f4 to f6, and f7 to f9, respectively, and for each group, a group code is assigned based on, among the nine subcarrier codes, the three subcarrier codes included in the group.

In the example illustrated in FIG. 16, for each group of the plurality of groups, the group code is determined based on, among the plurality of subcarrier codes, a most frequently occurring code value. In other words, for the group corresponding to the subcarriers at frequencies f1 to f3, the value 1, which occurs most frequently among the code values of the subcarrier codes, is assigned as the group code. Similarly, for the group corresponding to the subcarriers at frequencies f4 to f6, the value 1, which occurs most frequently, is assigned as the group code. For the group corresponding to the subcarriers at frequencies f7 to f9, the value 0, which occurs most frequently, is assigned as the group code. In the present variation, the reception code may be assigned based on the group code assigned to each of the plurality of groups. For example, in the example illustrated in FIG. 16, the reception code may be assigned based on the three group codes 1, 1, and 0.

Furthermore, as illustrated in FIG. 16, the plurality of groups may be determined based on the range to which the frequencies of the subcarriers (first subcarriers) belong. In other words, the frequencies of the first subcarriers in each of the plurality of groups may be adjacent to the frequencies of other first subcarriers in the same group. In still other words, for each group of the plurality of groups, a frequency of one first subcarrier, among the plurality of first subcarriers, that corresponds to an arbitrarily selected subcarrier code included in the group may be adjacent to a frequency of an other first subcarrier, among the plurality of first subcarriers, that corresponds to an other subcarrier code included in the group. Here, the arbitrarily selected subcarrier code and the other subcarrier code are each included in the plurality of subcarrier codes, and the other subcarrier code is a subcarrier code other than the arbitrarily selected subcarrier code.

As described above, by using group codes, reception device 40 can reliably detect the wake-up signal even when noise is superimposed on a specific subcarrier. In other words, the noise immunity of the wake-up signal can be further enhanced.

Furthermore the frequencies of the plurality of subcarriers corresponding to the plurality of subcarrier codes included in each group need not be adjacent to each other. For example, in the nine subcarriers illustrated in FIG. 16, the frequencies of the subcarriers corresponding to the subcarrier codes included in the first group may be f1, f4, and f7, the frequencies of the subcarriers corresponding to the subcarrier codes included in the second group may be f2, f5, and f8, and the frequencies of the subcarriers corresponding to the subcarrier codes included in the third group may be f3, f6, and f9. Thus dispersing the frequencies of the subcarriers corresponding to the subcarrier codes included in each group makes it possible for reception device 40 to reliably detect the wake-up signal, even when, for example, noise is superimposed in the frequency band from frequency f1 to frequency f3. In other words, the noise immunity of the wake-up signal can be further enhanced.

Furthermore, in the above-described embodiments, wake-up signal detector 50 detected the wake-up signal from the modulated signal that was analog data, but the configuration of the wake-up signal detector is not limited thereto. For example, the wake-up signal detector may detect the wake-up signal from digital data obtained by subjecting the modulated signal to A/D conversion processing.

Furthermore, the forms described below may also be included in the scope of one or a plurality of aspects of the present disclosure.
(1) One or more of the elements included in each of transmission device 20 and reception device 40 described above may be a computer system that includes a microprocessor, a ROM, a random access memory (RAM), a hard disk unit, a display unit, a keyboard, and a mouse, for instance. A computer program is stored in the RAM or the hard disk unit. The microprocessor achieves its functionality by operating in accordance with the computer program. Here, the computer program includes a combination of instruction codes indicating instructions to a computer in order to achieve predetermined functionality.
(2) One or more of the elements included in each of transmission device 20 and reception device 40 described above may include a single system large scale integration (LSI) circuit. A system LSI circuit is ultra-multifunctional LSI circuit manufactured by integrating a plurality of processing units on a single chip, and specifically, is a computer system including a microprocessor, ROM, RAM and the like. The RAM stores a computer program. The microprocessor operates according to the computer program, thereby enabling the system LSI circuit to achieve its functionality.
(3) One or more of elements included in each of transmission device 20 and reception device 40 described above may include an IC card or a standalone module which can be attached to or detached from the device. The IC card or the module is a computer system including a microprocessor, ROM, RAM, and any other suitable elements. The IC card or the module may be included in the above-described ultra-multifunctional LSI circuit. The IC card or the module achieves its functionality by the microprocessor operating in accordance with the computer program. The IC card or the module may be tamper resistant.
(4) One or more of the elements included in each of transmission device 20 and reception device 40 described above may be a computer program or digital signal stored on a non-transitory computer-readable recording medium, examples of which include a flexible disk, a hard disk, a CD-ROM, an MO, a DVD, a DVD-ROM, a DVD-RAM, a Blu-ray (registered trademark) disc (BD), semiconductor memory, and other media. Alternatively, one or more of the elements may be realized as the digital signal stored in such a recording medium.

Furthermore, one or more of the elements included in each of transmission device 20 and reception device 40 described above may be realized by transmitting the computer program or digital signal over an electrical communication line, a wireless or wired communication line, a network typified by the Internet, or via data broadcasting, for instance.
(5) The present disclosure may be a method described above. The present disclosure may be a computer program that realizes such a method using a computer or a digital signal that includes the computer program. Furthermore, the present disclosure may be realized as a non-transitory computer-readable recording medium, such as a CD-ROM, having the computer program recorded thereon.
(6) The present disclosure may be a computer system that includes a microprocessor and memory, the memory may store the computer program, and the microprocessor may operate in accordance with the computer program.
(7) The present disclosure may be implemented by another independent computer system by recording the program or the digital signal on the recording medium and transferring it, or by transferring the program or the digital signal via the network or the like.
(8) The embodiments described above and the variations described above may be combined with each other.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

This disclosure can be used in, for example, a remote speed control system for an electric kickboard, as a communication system that enables realizing a wake-up signal with high noise tolerance.

1. A reception method used in a communication system that includes a transmission device and a reception device and performs communication by using an Orthogonal Frequency Division Multiplexing (OFDM) scheme,
the reception device including a normal receiving mode and a power-saving mode each of which serves as an operating mode of the reception device, the power-saving mode being a mode in which the reception device consumes less power than in the normal receiving mode,
the OFDM scheme defining a plurality of subcarriers that include two or more subcarriers defined as a plurality of first subcarriers,
the reception method comprising:
receiving a modulated signal modulated by using the OFDM scheme;
obtaining a signal level of each of the plurality of first subcarriers the modulated signal;
assigning a plurality of subcarrier codes to the plurality of first subcarriers, on a one-to-one basis, based on the signal level of each of the plurality of first subcarriers;
assigning, to the modulated signal, a reception code determined based on the plurality of subcarrier codes; and
changing the operating mode of the reception device based on the reception code, wherein
in the changing, the operating mode of the reception device is changed from the power-saving mode to the normal receiving mode, when the reception code and a mode change code that is defined in advance match each other.

2. The reception method according to claim 1, wherein
in the assigning of the plurality of subcarrier codes, each of the plurality of subcarrier codes is assigned based on a result of comparison between a predetermined threshold value and the signal level.

3. The reception method according to claim 2, wherein
in the assigning of the plurality of subcarrier codes, the predetermined threshold value that is compared to the signal level of each of the plurality of first subcarriers is same in each comparison.

4. The reception method according to claim 1, wherein
the reception code includes information identifying a transmission source from which the modulated signal has been transmitted.

5. The reception method according to claim 1, wherein
a code length of the reception code is equal to a total number of the plurality of first subcarriers.

6. The reception method according to claim 1, wherein
an arbitrary code is usable as the mode change code.

7. The reception method according to claim 1, wherein
in the assigning of the reception code: the plurality of subcarrier codes are assigned to a plurality of groups; a group code is assigned to each group of the plurality of groups based on a subcarrier code, among the plurality of subcarrier codes, that is included in the group; and the reception code is assigned based on the group code assigned to each group of the plurality of groups.

8. The reception method according to claim 7, wherein
for each group of the plurality of groups, a frequency of one first subcarrier, among the plurality of first subcarriers, that corresponds to an arbitrarily selected subcarrier code included in the group is adjacent to a frequency of an other first subcarrier, among the plurality of first subcarriers, that corresponds to an other subcarrier code included in the group, the arbitrarily selected subcarrier code and the other subcarrier code each being included in the plurality of subcarrier codes, the other subcarrier code being a subcarrier code other than the arbitrarily selected subcarrier code.

9. The reception method according to claim 7, wherein
for each group of the plurality of groups, the group code is determined based on, among the plurality of subcarrier codes, a most frequently occurring code value in the group.

10. The reception method according to claim 8, wherein
for each group of the plurality of groups, the group code is determined based on, among the plurality of subcarrier codes, a most frequently occurring code value in the group.

11. A transmission method used in a communication system that includes a transmission device and a reception device and performs communication by using an Orthogonal Frequency Division Multiplexing (OFDM) scheme,
the reception device including a normal receiving mode and a power-saving mode each of which serves as an operating mode of the reception device, the power-saving mode being a mode in which the reception device consumes less power than in the normal receiving mode,
the transmission method comprising:
determining, for each of a plurality of subcarriers defined by the OFDM scheme, data to be transmitted;
performing Inverse Fast Fourier Transform (IFFT) on each of the plurality of subcarriers; and
converting, to analog data, digital data output in the performing, wherein
the transmission device includes a normal transmission mode and a wake-up signal transmission mode each of which is an operating mode of the transmission device, the wake-up signal transmission mode being a mode in which the transmission device transmits a wake-up signal for changing the operating mode of the reception device from the power-saving mode to the normal receiving mode,
the wake-up signal includes a plurality of codes each corresponding to a different one of the plurality of subcarriers, and
in the wake-up signal transmission mode, digital data input in the converting is the digital data output in the performing, when the data determined in the determining corresponds to the wake-up signal.

12. A reception device that performs communication by using an Orthogonal Frequency Division Multiplexing (OFDM) scheme,
the reception device including a normal receiving mode and a power-saving mode each of which serves as an operating mode of the reception device, the power-saving mode being a mode in which the reception device consumes less power than in the normal receiving mode,
the OFDM scheme defining a plurality of subcarriers that include two or more subcarriers defined as a plurality of first subcarriers,
the reception device comprising:
a signal level obtainer that receives a modulated signal modulated by using the OFDM scheme and obtains a signal level of each of the plurality of first subcarriers in the modulated signal;
a subcarrier code assigner that assigns a plurality of subcarrier codes to the plurality of first subcarriers, on a one-to-one basis, based on the signal level of each of the plurality of first subcarriers;
a reception code assigner that assigns, to the modulated signal, a reception code determined based on the plurality of subcarrier codes; and
an operating mode changer that changes the operating mode of the reception device based on the reception code, wherein
the operating mode changer changes the operating mode of the reception device from the power-saving mode to the normal receiving mode, when the reception code and a mode change code defined in advance match each other.

13. A transmission device that communicates with a reception device by using an Orthogonal Frequency Division Multiplexing (OFDM) scheme,
the reception device including a normal receiving mode and a power-saving mode each of which serves as an operating mode of the reception device, the power-saving mode being a mode in which the reception device consumes less power than in the normal receiving mode,
the transmission device comprising:
a mapper that determines, for each of a plurality of subcarriers defined by the OFDM scheme, data to be transmitted;
an Inverse Fast Fourier Transform (IFFT) component that performs IFFT on each of the plurality of subcarriers; and
a digital-to-analog (D/A) converter that converts, to analog data, digital data output by the IFFT component, wherein
the transmission device includes a normal transmission mode and a wake-up signal transmission mode each of which serves as an operating mode of the transmission device, the wake-up signal transmission mode being a mode in which the transmission device transmits a wake-up signal for changing the operating mode of the reception device from the power-saving mode to the normal receiving mode,
the wake-up signal includes a plurality of codes each corresponding to a different one of the plurality of subcarriers, and
in the wake-up signal transmission mode, digital data input to the D/A converter is the digital data output by the IFFT component, when the data determined by the mapper corresponds to the wake-up signal.

14. A communication system that performs communication by using an Orthogonal Frequency Division Multiplexing (OFDM) scheme, the communication system comprising:
a transmission device; and
a reception device, wherein
the reception device includes a normal receiving mode and a power-saving mode each of which serves as an operating mode of the reception device, the power-saving mode being a mode in which the reception device consumes less power than in the normal receiving mode,
the OFDM scheme defining a plurality of subcarriers that include two or more subcarriers defined as a plurality of first subcarriers,
the reception device includes:
a signal level obtainer that receives a modulated signal modulated by using the OFDM scheme and determines a signal level of each of the plurality of first subcarriers in the modulated signal;
a subcarrier code assigner that assigns a plurality of subcarrier codes to the plurality of first subcarriers, on a one-to-one basis, based on the signal level of each of the plurality of first subcarriers;
a reception code assigner that assigns, to the modulated signal, a reception code determined based on the plurality of subcarrier codes; and
an operating mode changer that changes the operating mode of the reception device based on the reception code, and
the operating mode changer changes the operating mode of the reception device from the power-saving mode to the normal receiving mode, when the reception code and a mode change code defined in advance match each other.
